(19) United States
(12) Patent Application Publication
(10) Pub. No.: US 2013/0046037 A1
(43) Pub. Date: Feb. 21, 2013

(54) PROCESS FOR PRODUCING RIGID POLYURETHANE FOAMS

(71) Applicants: Andreas EMGE, Shanghai (CN); Holger Seifert, Vsevolozhsk (RU); Daniel Freidank, Shanghai (CN)

(72) Inventors: Andreas EMGE, Shanghai (CN); Holger Seifert, Vsevolozhsk (RU); Daniel Freidank, Shanghai (CN)

(73) Assignee: BASF SE, Ludwigshafen (DE)

(21) Appl. No.: 13/586,598

(22) Filed: Aug. 15, 2012

Related U.S. Application Data
(60) Provisional application No. 61/524,354, filed on Aug. 17, 2011.

(51) Int. Cl. C08J 9/06; C08G 65/00; C08L 75/04

(52) U.S. Cl. 521/112; 521/137; 528/392

(57) ABSTRACT

The invention relates to particle-comprising polyurethane foams, wherein the particles are incorporated predominantly in the cell walls.

The invention relates to a process for producing rigid polyurethane foams by reacting polyisocyanates with compounds having at least two hydrogen atoms which are reactive toward isocyanate groups.

Rigid polyurethane foams have been known for a long time and have frequently been described in the literature. They are usually produced by reacting polyisocyanates with compounds having at least two hydrogen atoms which are reactive toward isocyanate groups, in particular polyfunctional alcohols. The rigid polyurethane foams are preferably used for damping in refrigeration appliances or for construction elements.

Improving the properties of the rigid polyurethane foams is an ongoing task. In particular, the thermal conductivity of the foams should be lowered and their mechanical properties, in particular the compressive strength, should be improved.

A possible way of achieving this objective is to use filler-comprising polyols in the production of the rigid foam. A frequently used group of filler-comprising polyols are those which are produced by in-situ polymerization of olefinically unsaturated monomers, in particular styrene and/or acrylonitrile, in polyols, in particular polyether alcohols. Such products are generally known and are referred to as polymer polyols or graft polyols.

Rigid polyurethane foams produced using graft polyols are described, for example, in WO2005/097863 and WO2004/035650. The rigid foams described there display a short demolding time, good mechanical properties and a low thermal conductivity.

Uniform distribution of the particles in the foam matrix is important for the properties of the foams. Good distribution means, in the first step, that no aggregates composed of a plurality of particles are formed but instead the filler is distributed uniformly in the polymer material. Only in this way can a filler be used in an economically feasible way. Such a distribution of the particles can be achieved, for example, using graft polyols as are described, for example, in WO2005/097863 and WO2004/035650.

Apart from the avoidance of aggregates, a further point is important for the distribution of the particles in the foam: normally, at least 80% of the polyurethane material is present in the cell struts of the rigid foam (see D. W. Reitz, M. A. Schütz, L. R. Glicksman “A basic study of aging of foam insulation”, Journal of cellular plastics, 1984, 20(2), 104-113.). Thus, virtually all particles are also present in the cell struts and only a few filler particles are also to be found in the cell wall. When a foam is subjected to a high mechanical compressive or tensile stress, the material begins to fail at the weak points, i.e. at the very thin cell wells, while the significantly stronger cell struts initially remain intact. If reinforcement of the foam by means of a filler is to be achieved, it is necessary for a very large proportion of the filler to be present in the cell walls, since only this part of all the filler used has a reinforcing action. According to the prior art, such a distribution of the filler with an increased concentration of the particles in the cell walls is not known.

The use of fillers for optimizing the properties of rigid polyurethane foams requires substantial control of the distribution of the individual particles in the foam.

It is an object of the present invention to provide polyurethane foams, in particular rigid polyurethane foams, which display good mechanical properties, a low thermal conductivity and good processing properties, for example a reduced demolding time. In particular, the compressive strength of the foams should be improved, which enables the density of the foams to be reduced. Furthermore, high compatibility of the starting components for production of the polyurethanes, in particular the polyol component, with the blowing agents, here particularly with the nonpolar hydrocarbons, should also be achieved.

The object has surprisingly been able to be solved by the particles being predominantly incorporated in the cell walls of the foams, where the particles are polymers of olefinically unsaturated monomers or inorganic particles and the surface of the particles has been modified by means of surface-active substances.

The invention accordingly provides particle-comprising polyurethane foams in which the particles are predominantly incorporated in the cell walls, where the particles are polymers of olefinically unsaturated monomers or inorganic particles and the surface of the particles has been modified by means of surface-active substances.

Here, the term “predominantly” means that at least 50% by weight of the particles, based on the total weight thereof, are incorporated in the cell walls.

The invention further provides a process for producing rigid polyurethane foams by reacting
a) polyisocyanates with
b) compounds having at least two hydrogen atoms which are reactive toward isocyanate groups in the presence of
c) blowing agents,
   wherein at least one of the components a) or b) comprises particles whose surface has been modified by means of surface-active substances.

The invention further provides particle-comprising polyether alcohols which can be prepared by in-situ polymerization of olefinically unsaturated monomers in a polyether alcohol, wherein at least one of the olefinically unsaturated monomers has surface-active properties.

The invention further provides a process for preparing particle-comprising polyether-alcohols by in-situ polymerization of olefinically unsaturated monomers in a polyether alcohol, wherein at least one of the olefinically unsaturated monomers has surface-active properties.

For the purposes of the present invention, surface-active means that the compounds compatibilize immiscible materials, in particular immiscible liquids or immiscible liquids and gases. Such compounds have groups which are compatible with the one material and groups which are compatible with the other material. The surface-active compounds therefore become attached to the interfaces between the immiscible materials.

The particles preferably have a size of less than 50 μm, in particular in the range 0.5-10 μm.

The particles are preferably selected from the group consisting of organic particles such as organic polymers or thermoplastic particles and inorganic particles, in particular carbon-rich particles such as carbon black or graphite, or oxides, in particular inorganic oxides.

As mentioned above, the surface of the particles has surface-active properties because they have been modified by means of surface-active substances. This can, in particular, be brought about by applying surfactants to the surface of the particles. The attachment of the surfactants to the particles can occur via noncovalent or preferably covalent bonds.

In a preferred embodiment of the invention, the particles are inorganic particles. They are preferably of the abovementioned carbon-rich particles such as carbon black or graphite or inorganic oxides, in particular metal oxides.

In the case of the inorganic particles, the surfactants are preferably brought into contact with the particles in such a way that they adhere to the surface of the particles.

In a further preferred embodiment of the invention, the particles are polymers of olefinically unsaturated monomers.

In this case, they can be thermoplastic particles which are dispersed in the components a) or preferably b). Such processes, also known as melt emulsion processes, are known and are described, for example, in WO 2009/138379.

Here too, the surfactants are, as in the case of the inorganic particles, preferably brought into contact with the particles in such a way that they adhere to the surface of the particles.

In a particularly preferred embodiment of the invention, the particles are produced by in-situ polymerization of olefinically unsaturated monomers in a polyol, in particular a polyether alcohol. Polyols prepared by this process are generally known and are frequently referred to as graft polyols.

The synthesis of graft polyols by the two processes is known and is described in a number of examples. Thus, the synthesis of graft polyols by the semibatch process is described in the following patents: EP 439755 and U.S. Pat. No. 4,522,976. A special form of the semibatch process is the semibatch seed process in which a graft polyol is additionally used as seed in the initial charge for the reaction, as described, for example, in EP 510533 and EP 698628. The synthesis of graft polyols by a continuous process is likewise known and is described, inter alia, in WO 00/59971 and WO 99/31160.

In the case of organic particles prepared by polymerization, in particular those prepared by in-situ polymerization of olefinically unsaturated monomers in a polyether alcohol, the surfactants are preferably introduced into the particles by at least one of the monomers preferably having surfactant groups and at least one olefinic group.

Such monomers can be prepared by reacting a surfactant which has at least one reactive group with a compound having a group which is reactive toward this group and an olefinically unsaturated group.

Preference is given to using surfactants which compatibilize liquid and gases by means of noncovalent interactions. Such compounds are frequently used as foam stabilizers in the production of polyurethanes.

Preferred examples of such surfactants are polyethersiloxanes which have at least one side chain having at least one hydroxyl group, for example polyethersiloxanes of the following formula

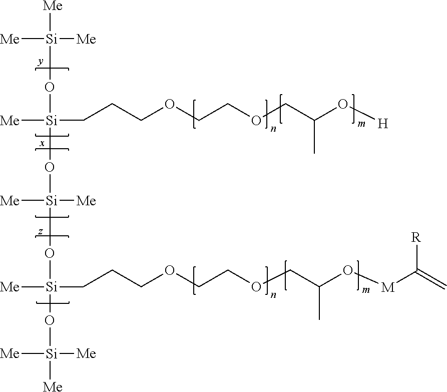

where x, y, z, n and m are numbers and R is an alkyl group having from 1 to 10 carbon atoms, M is a divalent aliphatic, aromatic or araliphatic group which has from 2 to 10 carbon atoms and is bound via an ether, ester, urethane, acetal group to the polyether chain. The sum of x, y, z is preferably selected so that the molecular weight of the siloxane chain in these compounds is, for example, from 2000 to 6000 g/mol, preferably from 4000 to 5500 g/mol. z is preferably 1 or 0, on average 0.9, y is preferably in the range from 3 to 20. x is thus defined. n and m are, according to the invention, preferably selected so that the side chain has a molecular weight of from 400 to 2500 g/mol. The ratio n/(n+m)is preferably in the range from 10 to 90%; values for m/(n+m) are preferably analogous.

The present invention therefore preferably provides the process of the invention in which polyethersiloxanes which have at least one side chain having at least one hydroxyl group are used as surfactants.

Furthermore, the present invention preferably provides the foam of the invention where the surface-active substances are polyethersiloxanes which have at least one side chain having at least one hydroxyl group.

Furthermore, the present invention preferably provides the particle-comprising polyether alcohols of the invention which can be prepared by in-situ polymerization of olefinically unsaturated monomers in a polyether alcohol, where at least one of the olefinically unsaturated monomers has surface-active properties as a result of the use of polyethersiloxanes which have at least one side chain having at least one hydroxyl group.

The present invention also preferably provides the process of the invention for preparing particle-comprising polyether alcohols by in-situ polymerization of olefinically unsaturated monomers in a polyether alcohol, where at least one of the olefinically unsaturated monomers has surface-active properties as a result of the use of polyethersiloxanes which have at least one side chain having at least one hydroxyl group.

The molecular weight of the siloxane chain in these compounds is, for example, from 2000 to 6000 g/mol, preferably from 4000 to 5500 g/mol. The molecular weight of these compounds is, for example, from 10,000 to 25,000 g/mol, preferably from 11,000 to 22,000 g/mol, particularly preferably from 11,000 to 20,000 g/mol.

The hydroxyl group can be reacted with an unsaturated compound having at least one group which is reactive toward isocyanate groups. These groups can be an acid group or an acid anhydride group. Examples of such unsaturated acids and acid derivatives are maleic anhydride (MAn), fumaric acid, acrylate derivatives and methacrylate derivatives. Preference is given to MAn. This group can preferably be an isocyanate group, since the resulting urethane group is more stable to hydrolysis than an ester group. Examples of unsaturated isocyanates are 3-isopropenyl-1,1-dimethylbenzyl isocyanate (TMI) and isocyanatoethyl methacrylate, with preference being given to TMI. These compounds having olefinically unsaturated groups are frequently referred to as macromers or stabilizers.

Further macromers which can be used in place or preferably in combination with the above-described compounds are usually linear or branched polyetherols which have molecular weights Mw of 1000 g/mol and comprise at least one usually terminal, reactive olefinically unsaturated group. The ethylenically unsaturated group can be inserted into an existing polyol by reaction with ethylenically unsaturated carboxylic acids and/or carboxylic anhydrides, e.g. maleic anhydride, fumaric acid, acrylate derivatives and methacrylate derivatives, and also unsaturated isocyananate derivatives such as 3-isopropenyl-1,1-dimethylbenzyl isocyanate, isocyanatoethyl methacrylate. Another route is preparation of a polyol by alkoxylation of propylene oxide and ethylene oxide using starter molecules having hydroxyl groups and ethylenic unsaturation.

Examples of such macromers are described in U.S. Pat. No. 4,390,645, U.S. Pat. No. 5,364,906 and U.S. Pat. No. 6,013,731.

The surfacants can be incorporated into the macromers.

In a further embodiment of the invention, the graft polyols are prepared by in-situ polymerization of olefinically unsaturated monomers in a polyether alcohol, with the graft particles being modified by reaction with a surface-active component after they have been produced.

In an embodiment of the invention, the surfactants do not comprise any halogen atoms, in particular do not comprise any fluorine atoms.

These monomers are attached to the surface of the particles in the preparation of the graft polyols.

As a result, the particles behave like surface-active substances.

The surface-active particles used according to the invention can additionally bear functional groups, preferably groups via which the particles can be chemically bound to the PU matrix. However, it is also possible for the particles according to the invention to bear no reactive functional groups on the surface.

As mentioned above, the foams of the invention are produced by reacting a) polyisocyanates with b) compounds having at least two hydrogen atoms which are reactive toward isocyanate groups, with at least one of the components a) or b), preferably the component b), comprising particles.

The incorporation of the particles into the component a) is less preferred since the higher reactivity of the polyisocyanates can lead to malfunctions and undesirable secondary reactions.

The component b) therefore preferably comprises the particles whose surface has been modified by means of surface-active substances.

The particle-comprising polyols, in particular polyether alcohols, can, as described, be produced in a preferred embodiment by in-situ polymerization of olefinically unsaturated monomers in polyether alcohols, frequently referred to as carrier polyols. These polyols are frequently referred to as graft polyols.

The carrier polyols are preferably prepared by addition of alkylene oxides, in particular ethylene oxide and/or propylene oxide, on to H-functional compounds, preferably those having hydroxyl or amino groups. The H-functional compounds can be alcohols having from 2 to 4 hydroxyl groups in the molecule. Preferred examples are glycerol, trimethylolpropane and glycols, for example ethylene glycol, diethylene glycol, propylene glycol and dipropylene glycol. In a further embodiment of the present invention, the H-functional compounds are primary or secondary amines having from 2 to 4 reactive hydrogen atoms. Examples of aliphatic amines are ethylenediamine, propylenediamine and ethanolamine. Preference is given to using aromatic amines, preferably toluenediamine and here in particular the ortho isomers.

The carrier polyols preferably have a hydroxyl number in the range from 40 to 250 mg KOH/g.

The solids content of the graft polyol is preferably in the range from 30 to 55% by weight, based on the weight of the graft polyol.

As olefinically unsaturated monomers, preference is given to using styrene and/or acrylonitrile, particularly preferably mixtures of styrene and acrylonitrile. The acrylonitrile content of these mixtures is particularly preferably in the range from 30 to 80% by weight, based on the mixture.

The graft polyols b1) preferably have a particle size of the polymers of from 0.1 μm to 8 μm, preferably from 0.2 μm to 4 μm with a maximum in the particle size at from 0.2 to 3 μm, preferably at 0.2 to 2.0 μm.

In a further preferred embodiment of the graft polyols b1), the particle size distribution is bimodal, i.e. the distribution curve of the particle size has two maxima. Such graft polyols can, for example, be produced by mixing of graft polyols having a monomodal particle size distribution and different particle sizes in the appropriate ratio or by using a polyol which already comprises polymers of olefinically unsaturated monomers as carrier polyol in the initial charge for the reaction. In this embodiment, too, the particle size is in the above-described range.

In an embodiment of the invention, the graft polyols can be prepared continuously.

In a further, preferred embodiment, the graft polyols are prepared by the semibatch process.

As regards the production of the polyurethane foams, in particular rigid foams, the following details may be provided.

Possible organic polyisocyanates a) are preferably aromatic polyfunctional isocyanates.

Specific examples are: tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products obtained by chemical reaction of organic diisocyanates and/or polyisocyanates. Examples which may be mentioned are diisocyanates and/or polyisocyanates comprising isocyanurate and/or urethane groups. The modified polyisocyanates can optionally be mixed with one another or with unmodified organic polyisocyanates such as diphenylmethane 2,4′-, 4,4′-diisocyanate, crude MDI, tolylene 2,4- and/or 2,6-diisocyanates.

In addition, reaction products of polyfunctional isocyanates with polyhydric polyols and also mixtures thereof with other diisocyanates and polyisocyanates can also be used.

Crude MDI having an NCO content of from 29 to 33% by weight and a viscosity at 25° C. in the range from 150 to 1000 mPa·s has been found to be particularly useful as organic polyisocyanate.

The particle-comprising polyol bi1) can in principle be used as sole compound b) having at least two hydrogen atoms which are reactive toward isocyanate groups. However, this compound b1) is preferably used in admixture with other compounds having at least two hydrogen atoms which are reactive toward isocyanate groups.

For this purpose, it is possible to use the customary and known compounds having at least two hydrogen atoms which are reactive toward isocyanate groups. Preference is given to using polyether alcohols and/or polyester alcohols in combination with the polyols b1).

The polyester alcohols used together with the polyols b1) are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyether alcohols used together with the polyols b1) usually have a functionality in the range from 2 to 8, in particular from 3 to 8.

In particular, polyether alcohols prepared by known methods, for example by anionic polymerization of alkylene oxides in the presence of catalysts, preferably alkali metal hydroxides, are used.

As alkylene oxides, use is usually made of ethylene oxide and/or propylene oxide, preferably pure 1,2-propylene oxide.

As starter molecules, use is made, in particular, of compounds having at least 3, preferably from 4 to 8, hydroxyl groups or at least two primary amino groups in the molecule.

As starter molecules having at least 3, preferably from 4 to 8, hydroxyl groups in the molecule, preference is given to using trimethylolpropane, gycerol, pentaerythritol, sugar compounds such as glucose, sorbitol, mannitol and sucrose, polyhydric phenols, resols such as oligomeric condensation products of phenol and formaldehyde and Mannich condensates of phenols, formaldehyde and dialkanolamines and also melamine.

As starter molecules having at least two primary amino groups in the molecule, preference is given to using aromatic diamines and/or polyamines, for example phenylenediamines, 2,3-, 2,4-, 3,4- and 2,6-toluenediamine (TDA), in particular 2,3- and 3,4-TDA, and 4,4′-, 2,4′- and 2,2′-diaminodiphenylmethane, and also aliphatic diamines and polyamines such as ethylenediamine. The 2,3- and 3,4-isomers of TDA are also referred to as vicinal TDA.

The polyether alcohols have a functionality of preferably from 3 to 8 and hydroxyl numbers of preferably from 100 mg KOH/g to 1200 mg KOH/g and in particular from 240 mg KOH/g to 570 mg KOH/g.

In a preferred embodiment of the process of the invention, a mixture of the graft polyol bi1) and at least one polyether alcohol bii2) initiated using an aliphatic amine is used as compounds having at least two hydrogen atoms which are reactive toward isocyanate groups. This polyether alcohol bii2) preferably has a hydroxyl number in the range from 375 to 525 mg KOH/g.

In a further preferred embodiment of the process of the invention, a mixture of the graft polyol bi1) and at least one polyether alcohol bii3) initiated using an aromatic amine is used as compounds having at least two hydrogen atoms which are reactive toward isocyanate groups. This polyether alcohol bii3) preferably has a hydroxyl number in the range from 375 to 525 mg KOH/g. Furthermore, polyether alcohols initiated using vicinal TDA and having a hydroxyl number of from 100 to 250 mg KOH/g can be used as polyol bii3).

In a further preferred embodiment of the process of the invention, a mixture of the graft polyol bi1) and at least one polyether alcohol bii4) initiated using a sugar, in particular sorbitol or sucrose, is used as compounds having at least two hydrogen atoms which are reactive toward isocyanate groups. This polyether alcohol bii4) preferably has a hydroxyl number in the range from 300 to 700 mg KOH/g.

In a further preferred embodiment of the process of the invention, a mixture of the graft polyol bit) and at least one polyether alcohol bii5) initiated using a trihydric alcohol, in particular glycerol and/or trimethylolpropane, is used as compounds having at least two hydrogen atoms which are reactive toward isocyanate groups. This polyether alcohol bii5) preferably has a hydroxyl number in the range from 100 to 250 mg KOH/g.

In a further preferred embodiment of the invention, polyol bi) or bii) comprises a polyether alcohol bii6) initiated using a bifunctional alcohol.

In a further preferred embodiment of the invention, compound b) comprises at least one polyol bii1), at least one polyol bii4) and at least one polyol bii2) and/or bii3).

Preferred polyol components comprise polyol bii1 in a proportion of 10-30% by weight, polyol bii2 in a proportion of 0-15% by weight, bii3 in a proportion of 15-40% by weight, bii4 in a proportion of 25-60% by weight and bii5 in a proportion of 0-15% by weight.

The compounds b) having at least two hydrogen atoms which are reactive toward isocyanate also include the chain extenders and crosslinkers which may optionally be concomitantly used. The rigid polyurethane foams can be produced with or without use of chain extenders and/or crosslinkers. The addition of bifunctional chain extenders, trifunctional and higher-functional crosslinkers or optionally mixtures thereof can be advantageous for modifying the mechanical properties. As chain extenders and/or crosslinkers, preference is given to using alkanolamines and in particular diols and/or triols having molecular weights of less than 400, preferably from 60 to 300.

Chain extenders, crosslinkers or mixtures thereof are advantageously used in an amount of from 1 to 20% by weight, preferably from 2 to 5% by weight, based on the compounds b) having at least two hydrogen atoms which are reactive toward isocyanate groups.

The reaction is usually carried out in the presence of catalysts, blowing agents and customary auxiliaries and/or additives.

As catalysts, use is made, in particular, of compounds which strongly accelerate the reaction of the isocyanate groups with the groups which are reactive toward isocyanate groups.

Such catalysts are strongly basic amines such as secondary aliphatic amines, imidazoles, amidines and also alkanolamines or organic metal compounds, in particular organic tin compounds.

If isocyanurate groups are also to be incorporated into the rigid polyurethane foam, specific catalysts are required for this purpose. As isocyanurate catalysts, use is usually made of metal carboxylates, in particular potassium acetate and solutions thereof.

The catalysts can, depending on requirements, be used either alone or in any mixtures with one another.

As blowing agent, preference is given to using water which reacts with isocyanate groups to eliminate carbon dioxide. It is also possible to use physical blowing agents in combination with or in place of water. These are compounds which are inert toward the starting components and are usually liquid at room temperature and vaporized under the conditions of the urethane reaction. The boiling point of these compounds is preferably below 50° C. Physical blowing agents also include compounds which are gaseous at room temperature and are introduced under superatmospheric pressure into the starting components or are dissolved therein, for example carbon dioxide, low-boiling alkanes and fluoroalkanes.

The compounds are usually selected from the group consisting of alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and 1,1,1,2,3,3,3-heptafluoropropane, and also perfluoroalkanes such as: C₃F₈, C₄F₁₀, C₅F₁₂, C₆F₁₄ or C₇F₁7. The abovementioned physical blowing agents can be used either alone or in any combinations with one another.

The blowing agent particularly preferably comprises at least one aliphatic hydrocarbon which preferably comprises at least 4 carbon atoms. In a preferred embodiment of the process of the invention, a combination of water and an aliphatic hydrocarbon is used as blowing agent. Preferred hydrocarbons are n-pentane, isopentane and cyclopentane.

Particularly when hydrocarbons are used as blowing agent, optimal incorporation of the particles into the cell walls can occur.

The process of the invention can, if required, be carried out in the presence of flame retardants and also customary auxiliaries and/or additives.

As flame retardants, it is possible to employ organic phosphoric and/or phosphonic esters. Preference is given to using compounds which are not reactive toward isocyanate groups. Chlorine-comprising phosphoric esters are also among the preferred compounds.

Typical representatives of this group of flame retardants are triethyl phosphate, diphenyl cresyl phosphate, tris(chloropropyl) phosphate and diethylethanephosphonate.

In addition, bromine-containing flame retardants can also be used. As bromine-containing flame retardants, preference is given to using compounds which have groups which are reactive toward the isocyanate group. Such compounds are, for example, esters of tetrabromophthalic acid with aliphatic diols and alkoxylation products of dibromobutenediol. Compounds derived from the group of brominated neopentyl compounds comprising OH groups can also be employed.

As auxiliaries and/or additives, use is made of the materials known per se for this purpose, for example surface-active substances, foam stabilizers, cell regulators, fillers, pigments, dyes, flame retardants, hydrolysis inhibitors, antistatics, fungistatic and bacteriostatic agents.

Further details regarding the starting materials, blowing agents, catalysts and auxiliaries and/or additives used for carrying out the process of the invention may be found, for example, in the Kunststoffhandbuch, volume 7, “Polyurethane” Carl-Hanser-Verlag, Munich, 1st edition, 1966, 2nd edition, 1983 and 3rd edition, 1993.

To produce the rigid polyurethane foams, the polyisocyanates a) and the compounds b) having at least two hydrogen atoms which are reactive toward isocyanate groups are reacted in such amounts that the isocyanate index is in the range from 100 to 220, preferably from 115 to 195. The rigid polyurethane foams can be produced batchwise or continuously using known mixing apparatuses.

The production of polyisocyanurate foams can also be carried out at a higher index, preferably up to 350.

The rigid PUR foams of the invention are usually produced by the two-component process. In this process, the compounds b) having at least two hydrogen atoms which are reactive toward isocyanate groups are mixed with the flame retardants, the catalysts c), the blowing agents d) and also the further auxiliaries and/or additives to give a polyol component and this is reacted with the polyisocyanates or mixtures of the polyisocyanates and optionally blowing agents, also referred to as isocyanate components.

The starting components are usually mixed at a temperature of from 15 to 35° C., preferably from 20 to 30° C. The reaction mixture can be cast into closed support tools by means of high- or low-pressure metering machines.

In addition, the reaction mixture can also be poured or sprayed free onto surfaces or into open hollow spaces. Roofs and complicated containers can be insulated in-situ by this method. The reaction mixture can also be introduced at one point or simultaneously at a plurality of points into a closed mold which may also have a complex geometry. The reaction mixture can be injected at various places on the mold. The mold can have a different alignment in three-dimensional space at the point in time at which the reaction mixture is injected. The production of refrigeration appliances is a typical example of such processes. The reaction mixture can likewise be poured into an open mold which is closed after it has been filled. This procedure is, for example, typical for the production of doors for refrigeration appliances.

Preparation of the Graft Polyols

The graft polyols used in the following examples can be prepared in continuous processes and discontinuous processes. The synthesis of graft polyols by the two processes is known. The synthesis of graft polyols by the semibatch process is described, for example, in EP 439755. A special form of the semibatch process is the semibatch seed process in which a graft polyol is additionally used as seed in the initial charge for the reaction, for example as described in EP 510533. The synthesis of graft polyols having a bimodal particle size distribution is described in WO 03/078496. The synthesis of graft polyols by a continuous process is likewise known and is described, for example, in: WO 00/59971.

### GRAFT POLYOLS FOR THE EXAMPLES AND COMPARATIVE EXAMPLES PREPARED BY THE SEMIBATCH PROCESS

The preparation of the graft polyols for the examples and comparative examples by the semibatch process was carried out in a 2 liter autoclave equipped with 2-stage stirrer, internal cooling coils and electric heating mantel. Before commencement of the reaction, the reactor was charged with a mixture of carrier polyol and macromer, flushed with nitrogen and heated to the synthesis temperature of 125 or 130° C. In some syntheses, a graft polyol was additionally added as seed to the initial charge for the reaction, in addition to the carrier polyol and the macromer. In a further group of experiments, only part of the macromer was initially introduced into the reactor. The remaining amount was introduced into the reactor during the synthesis via an independent feed stream.

The remainder of the reaction mixture comprised further carrier polyol, initiator, the monomers and the reaction moderator was placed in at least two feed vessels. The synthesis of the graft polyols was carried out by transferring the raw materials from the feed vessels at a constant feed rate into the reactor via a static in-line mixer. The introduction time for the monomer/moderator mixture was 150 or 180 minutes, while the polyol/initiator mixture was metered into the reactor over 165 or 195 minutes. After a further after-reaction time of from 10 to 30 minutes at the reaction temperature, the crude graft polyol was transferred via the bottom outlet valve into a glass flask. The product was subsequently freed of the unreacted monomer and other volatile compounds at a temperature of 135° C. under reduced pressure (<0.1 mbar). The end product was subsequently stabilized with antioxidants.

A specific macromer was used for the graft polyols 5-7. This was a polyethersiloxane corresponding to the following formula

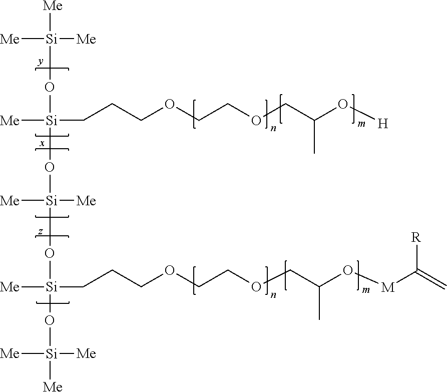

where x, y, z, n and m are numbers having the values given in the description and R is an alkyl group having from 1 to 10 carbon atoms, M is a divalent aliphatic, aromatic or araliphatic group which has from 2 to 10 carbon atoms and is bound via an ether, ester, urethane, acetal group to the polyether chain, e.g. Tegostab B8462, is reacted with dimethyl-meta-isopropenylbenzyl. isocyanate (TMI) at 80° C. using a molecular deficiency of TMI so that statically not more than one OH group per polyethersiloxane molecule is reacted.

Production of Rigid Foams (Machine Foaming)

The various polyols, stabilizers, catalysts are mixed with water and the blowing agent in the ratios indicated in Table 1. 100 parts by weight of the polyol component were mixed with the amount indicated in each case in Table 1 of a mixture of diphenylmethane diisocyanate and polyphenylenepolymethylene polyisocyanate having an NCO content of 31.5% by weight and a viscosity of 200 mPa·s (25° C.) in a Puromat® HD 30 (Elastogran GmbH) high-pressure foaming machine. The reaction mixture was injected into a mold having the dimensions 200 cm×20 cm×5 cm or 40 cm×70 cm×9 cm and left there to foam. The properties and characteristic data of the foams obtained are shown in Table 1.

The rigid polyurethane foams produced by the process of the invention can be produced with a very short demolding time on the basis of a phase-stable polyol component, which allows significantly shortened cycle times. Despite the presence of the graft polyol, large amounts of physical blowing agents are soluble in the polyol component, so that foam densities in the components of less than 30 g/l can be achieved. The foam properties in respect of compressive strength, thermal conductivity and quality of the foam surfaces (formation of sinkholes) are excellent.

The polyurethane reaction mixture was poured into a mold having dimensions of 200×20×5 cm³ (10% overfilling) and, after some hours, a test specimen having the dimensions 20×20×2 cm³ was cut from the middle.

The compressive strength was determined in accordance with DIN 53421/DIN EN ISO 604.

The proportion of particles in the cell walls was determined by quantitative evaluation of scanning electron micrographs of the foams.

Determination of the proportion of particles in the cell walls: scanning electron micrographs, statistical evaluation of the particles.

The invention is illustrated by the following examples. All data are in parts by weight unless specified otherwise. Index and flow factor do not have a unit.

| | Compara- | Compara- | | | |
|---|---|---|---|---|---|
| | tive | tive | | | |
| | example 1 | example 2 | Example 1 | Example 2 | Example 3 |
| Polyol 1 | 25 | 25 | 25 | 25 | 25 |
| Polyol 2 | 52 | 52 | 52 | 52 | 52 |
| Polyol 3 | 16 | 13 | 13 | 13 | 13 |
| Polyol 4 | — | 3 | — | — | — |
| Polyol 5 | — | — | 3 | — | — |
| Polyol 6 | — | — | — | 3 | — |
| Polyol 7 | — | — | — | — | 3 |
| Stabilizer | 2 | 2 | 0.4 | 0.4 | 2 |
| Water | 2.3 | 2.3 | 2.3 | 2.3 | 2.3 |
| Catalyst | 1.8 | 1.8 | 1.8 | 1.8 | 1.8 |
| Cyclo- | 9.8 | 9.8 | 9.8 | 9.8 | 9.8 |
| pentane | | | | | |
| Isopentane | 4.2 | 4.2 | 4.2 | 4.2 | 4.2 |
| Formic acid | — | 2.3 | — | 2.3 | — |
| Index | 117 | 117 | 117 | 117 | 117 |
| Fiber time | 43 | 40 | 37 | 40 | 38 |
| [s] | | | | | |
| Free-foamed | 23.8 | 24.5 | 23.9 | 24.3 | 24.5 |
| density [g/l] | | | | | |

| | Compara- | Compara- | | | |
|---|---|---|---|---|---|
| | tive | tive | | | |
| | example 1 | example 2 | Example 1 | Example 2 | Example 3 |
| Minimum | 31.9 | 32.1 | 29 | 31.6 | 31.8 |
| fill density | | | | | |
| [g/l] | | | | | |
| Flow factor | 1.31 | 1.31 | 1.33 | 1.30 | 1.30 |
| (min. fill | | | | | |
| density/free | | | | | |
| foam density | | | | | |
| Proportion of | 6 | 5 | 6 | 5 | 4 |
| open cells | | | | | |
| [%] | | | | | |
| Thermal | 18.8 | 19.6 | 18.8 | 19.8 | 19.5 |
| conductivity | | | | | |
| [mW/mK] | | | | | |
| Compressive | 0.16 | 0.16 | 0.20 | 0.21 | 0.20 |
| strength | | | | | |
| (FD 31) 20% | | | | | |
| overpack, | | | | | |
| [N/mm²] | | | | | |
| Further rise | 93.2 | 92.8 | 91.8 | 91.3 | 91.5 |
| after 24 h, | | | | | |
| 4 min. 20% | | | | | |
| overpack | | | | | |
| [mm] | | | | | |
| Proportion | 0% | 10% | 60% | 70% | 60% |
| of filler in | | | | | |
| the cell wall | | | | | |

Polyol 1—Polyether alcohol derived from vicinal TDA and ethylene oxide and propylene oxide, hydroxyl number 390 mg KOH/g

Polyol 2—Polyether alcohol derived from sucrose, glycerol and propylene oxide, hydroxyl number 440 mg KOH/g

Polyol 3—Polyether alcohol derived from vicinal TDA and ethylene oxide and propylene oxide, hydroxyl number 160 mg KOH/g

Polyol 4—Graft polyol, hydroxyl number 19 mg KOH/g, prepared by in-situ polymerization of styrene and acrylonitrile in a polyether alcohol derived from glycerol and propylene oxide, hydroxyl number 35 mg KOH/g. Macromer is a reaction product of sorbitol with ethylene oxide/propylene oxide and TMI, molecular weight 18,000 g/mol.

Polyol 5—Graft polyol analogous to polyol 4, prepared in the presence of a polyethersiloxane surfactant, i.e.—macromers corresponding to the abovementioned formula. The molar weight of the siloxane chain in this compound is 4400 g/mol, in the side chain 81% ethylene oxide and 19% propylene oxide are present, the molecular weight of these compounds is 13,000 g/mol.

Polyol 6—Graft polyol analogous to polyol 4, prepared in the presence of a polyethersiloxane surfactant, i.e.—macromers corresponding to the abovementioned formula. The molar weight of the siloxane chain in this compound is 5050 g/mol, in the side chain 60% ethylene oxide and 40% propylene oxide are present, the molecular weight of the compounds is 19,000 g/mol.

Polyol 7—Graft polyol analogous to polyol 4, prepared in the presence of a polyethersiloxane surfactant, i.e.—macromers corresponding to the abovementioned formula. The molar weight of the siloxane chain in this compound is 5050 g/mol, in the side chain 60% ethylene oxide and 40% propylene oxide are present, the molecular weight of these compounds is 16,000 g/mol.

Stabilizer is Tegostab B8462

Catalyst is a mixture of N,N-dimethylcyclohexylamine, N,N,N′,N″,N″′-pentamethyldiethylenetriamine and Lupragen N600 (1,3,5-tris(dimethylaminopropyl)-sym-hexahydrotriazine; S-triazine) in the ratio 53:26:21.

The foams according to the invention have an increased compressive strength. The foam density of the foam according to the invention can thus in future be reduced further than in the case of conventional foams.

A further advantage is good curing of the surface zone of the foam. Even after a short demolding time, the foam is firm and less soft and deformable than in the case of the comparative formulations. This gives advantages in the handling of the freshly produced foam.

1. A particle-comprising polyurethane foam, wherein the particles are incorporated predominantly in the cell walls, the particles are polymers of olefinically unsaturated monomers or inorganic particles and the surface of the particles has been modified by means of surface-active substances.

2. The foam according to claim 1, wherein the surface-active substances are polyethersiloxanes which have at least one side chain having at least one hydroxyl group.

3. A process for producing rigid polyurethane foams by reacting
a) polyisocyanates with
b) compounds having at least two hydrogen atoms which are reactive toward isocyanate groups in the presence of
c) blowing agents,
wherein at least one of the components a) or b) comprises particles whose surface has been modified by means of surface-active substances.

4. The process according to claim 3, wherein polyethersiloxanes which have at least one side chain having at least one hydroxyl group are used as surfactants.

5. The process according to claim 3 or 4, wherein the particles are present in the component b).

6. The process according to any of claims 3 to 5, wherein the component b) comprises at least one particle-comprising polyether alcohol bi) which comprises at least two hydrogen atoms which are reactive toward isocyanate groups and has been prepared by in-situ polymerization of olefinically unsaturated monomers in a polyether alcohol, where at least one of the monomers comprises an olefinically unsaturated bond and a surface-active group.

7. The process according to any of claims 3 to 6, wherein the component b) comprises at least one particle-comprising polyether alcohol bi) which comprises at least two hydrogen atoms which are reactive toward isocyanate groups and has been prepared by in-situ polymerization of olefinically unsaturated monomers in a polyether alcohol, where the graft particles are modified by reaction with a surface-active component after they have been produced.

8. The process according to any of claims 3 to 7, wherein the component b) comprises at least one further polyol bii).

9. The process according to any of claims 3 to 8, wherein the polyol bi) or bii) comprises a polyether alcohol bii2) initiated using an aliphatic amine.

10. The process according to any of claims 3 to 8, wherein the polyol bi) or bii) comprises a polyether alcohol bii3) initiated using an aromatic amine.

11. The process according to any of claims 3 to 8, wherein the polyol bi) or bii) comprises a polyether alcohol bii4) initiated using a sugar.

12. The process according to any of claims 3 to 8, wherein the polyol bi) or bii) comprises a polyether alcohol bii5) initiated using a trifunctional alcohol.

13. The process according to any of claims 3 to 8, wherein the polyol bi) or bii) comprises a polyether alcohol bii6) initiated using a bifunctional alcohol.

14. The process according to any of claims 3 to 13, wherein compound b) comprises at least one polyol bii4) and at least one polyol bi1) and/or bii2).

15. A particle-comprising polyether alcohol which can be prepared by in-situ polymerization of olefinically unsaturated monomers in a polyether alcohol, wherein at least one of the olefinically unsaturated monomers has surface-active properties.

16. A process for preparing particle-comprising polyether alcohols by in-situ polymerization of olefinically unsaturated monomers in a polyether alcohol, wherein at least one of the olefinically unsaturated monomers has surface-active properties.

17. The process for preparing particle-comprising polyether alcohols according to claim 15 by in-situ polymerization of olefinically unsaturated monomers in a polyether alcohol, wherein the preparation is carried out in a semibatch process.
